(19) United States
(12) Patent Application Publication
(10) Pub. No.: US 2002/0033411 A1
(43) Pub. Date: Mar. 21, 2002

(54) Method and apparatus for flex circuit reflow attachment

(76) Inventors: Michael J. Peterson, Prior Lake, MN (US); Robert M. Echols, Yukon, OK (US); Erik J. Lindquist, Oakdale, MN (US); Darryl W. Leslie, Oklahoma City, OK (US)

Correspondence Address: Christopher L. Holt, WESTMAN CHAMPLIN & KELLY, Suite 1600 - International Centre, 900 South Second Avenue, Minneapolis, MN, 55402-3319, US

(21) Appl. No.: 09/893,800

(22) Filed: Jun. 28, 2001

Related U.S. Application Data
(60) Provisional application No. 60/233,921, filed on Sep. 20, 2000.

(51) Int. Cl. B23K 31/02; B23K 31/00

(52) U.S. Cl. 228/180.22; 228/215

(57) ABSTRACT

A flex circuit apparatus for a disc drive is provided and is configured to limit a collapse of a chip during a reflow attachment of the chip to a flex circuit substrate. The apparatus includes a connection pad and a trace operably disposed on an operating surface of the flex circuit substrate. The trace is adjacently and operably connected to the connection pad. A barrier crosses the trace and is configured to limit a flow of material down the trace. In another embodiment, a method for limiting a collapse of a chip during reflow attachment of the chip to a flex circuit substrate is provided. STL 9879

### CROSS-REFERENCE TO RELATED APPLICATION

This application is based on and claims the priority of an earlier filed co-pending U.S. provisional application Ser. No. 60/233,921, filed Sep. 20,2000, entitled “SOLDER WETTING FLOW OUT CONTAINMENT IN REFLOWABLE ENCAPSULANT PROCESSING.”

### FIELD OF THE INVENTION

The present invention relates to disc drive systems. More specifically, the present invention relates to flex circuit devices in disc drive systems.

### BACKGROUND OF THE INVENTION

Disc drives are the primary devices employed for mass storage of computer programs and data used in computer systems. Within a disc drive, a load beam supports a hydrodynamic air bearing (or slider) proximate a rotating disc. The load beam supplies a downward force that counteracts the hydrodynamic lifting force developed by the air bearing. The slider carries a transducer for communicating with individual bit positions on the rotating magnetic disc. The combination of a slider and a transducer is generally called a head.

A gimbal structure is typically located between the load beam and the slider. The gimbal resiliently supports the slider and allows it to pitch and roll while it follows the topography of the rotating disc.

The load beam is coupled to an actuator arm, which is, in turn, coupled to an actuator system. The actuator system positions the slider, and hence the transducer, relative to the disc to access desired tracks on the disc. A controller is typically associated with the actuator system and outputs positioning instructions to the actuator system based on input signals received from other components of a computer system.

Many disc drives incorporate flex circuits that function in cooperation with other disc drive components. Flex circuits provide many advantages over comparable alternatives, such as a lower cost, increased robustness and compactability. With the current industry trend towards portable computers, there has been a corresponding need to produce disc drives that are both incorporated in smaller packages and able to withstand the higher shock and vibration forces that are naturally to be expected when computers of this type are transported from place to place. Flex circuits help satisfy this need.

Incorporating flip chip assemblies into flex circuits allows for an elimination of space-wasting individual chip packages. Instead of utilizing chip packages, flip chips are directly connected to a substrate. In most instances, contact connectors located on a bottom surface of the flip chip match and are designed to be connected to corresponding pad connectors on the substrate. Neither bond wires, nor the space associated with bond wires, are needed. Because a typical connection between a flip chip and a flex circuit substrate is considerably shorter than a bond wire connection, a flip chip connection eliminates the high-speed performance penalties of conventional bond wire connections.

A flip chip is typically connected to a flex circuit substrate through solder bump connections between pads located on the flex circuit substrate and contacts located on the bottom of a flip chip. In addition to connecting the pads and contacts, the solder bump connections also effectively connect the flip chip contacts to traces disposed on the flex circuit substrate, the traces being operably connected to the substrate pads.

During the process of forming solder bump connections in flex circuits, it is not uncommon for solder material to wet out down the traces. For instance, after the contacts of a flip chip have been aligned with and engaged to solder wet flex circuit connection pads, the weight of the chip itself can encourage solder flow down traces. Surface tension characteristics of the liquid solder can also encourage solder flow down traces. Generally, as the amount of liquid solder placed on flex circuit connection pads increases, the amount and likelihood of flow out down the corresponding traces also increases.

To some degree, solder flow down traces can be desirable. For instance, solder in a trace can be an indication of an effective chip-substrate connection. However, as solder flows down traces, the height at which the flip chip sits upon solder bumps decreases. This decrease in height or collapse of the chip is undesirable for at least two reasons. First, due to column effect characteristics, a high sitting chip will typically demonstrate a better resiliency and ability to absorb shock than a low sitting chip. Second, as the height of the chip decreases, a risk of the chip making contact with the flex circuit substrate increases. Such contact between chip and substrate can lead to undesirable short circuit occurrences.

### SUMMARY OF THE INVENTION

An embodiment of the present invention pertains to a flex circuit apparatus for a disc drive. The apparatus is configured to limit a collapse of a chip during a reflow attachment of the chip to a flex circuit substrate. The apparatus includes a connection pad and a trace operably disposed on an operating surface of the flex circuit substrate. The trace is adjacently and operably connected to the connection pad. A barrier crosses the trace and is configured to limit a flow of material down the trace.

Another embodiment of the present invention pertains to a method for limiting a collapse of a chip during a reflow attachment of the chip to a flex circuit substrate. The method includes obtaining a chip having an operating surface that has a plurality of connection bumps. The method also includes obtaining a flex circuit substrate that includes a connection surface having a plurality of connection pads that are substantially aligned with the plurality of connection bumps. At least one of the connection pads is a non-operational traceless pad. Reflowable material is positioned on the plurality of connection pads and the plurality of connection bumps are connected to the corresponding plurality of connection pads.

Still another embodiment of the present invention pertains to a flex circuit apparatus that includes a chip, a flex circuit substrate and means for limiting a collapse of the chip during a reflow attachment of the chip to the flex circuit substrate.

These and various other features, as well as advantages which characterize the present invention, will be apparent upon reading of the following detailed description and review of the associated drawings.

### BRIEF DESCRIPTION OF THE DRAWINGS

FIG. 1 is a top plan view of a disc drive in which the present invention is particularly useful.

FIG. 2 is an isometric view of a flex circuit apparatus in which the present invention is particularly useful.

FIG. 3 is a longitudinal section taken through the flex circuit apparatus of FIG. 2 after a reflowable material has been positioned.

FIG. 4 is a longitudinal section taken through the flex circuit apparatus of FIG. 2 after a connection of a flip chip portion and a flex circuit substrate portion of the apparatus.

FIG. 5 is a longitudinal section similar to the section of FIG. 4 but including a cover layer barrier in accordance with an embodiment of the present invention.

FIG. 6 is an isometric view of a flex circuit substrate having a plurality of barrier strips, in accordance with an embodiment of the present invention.

FIG. 7 is a longitudinal section taken through the flex circuit substrate of FIG. 6 and a flip chip, after reflowable material has been positioned and after a connection of the flip chip to the flex circuit substrate.

FIG. 8 is an isometric view of a flex circuit apparatus including a flip chip, and a flex circuit substrate that includes traceless pad connections, in accordance with an embodiment of the present invention.

FIG. 9 is a longitudinal section taken through the flex circuit apparatus of FIG. 8, after a reflowable material has been positioned and after a connection of the flip chip to the flex circuit substrate.

### DETAILED DESCRIPTION OF ILLUSTRATIVE EMBODIMENTS

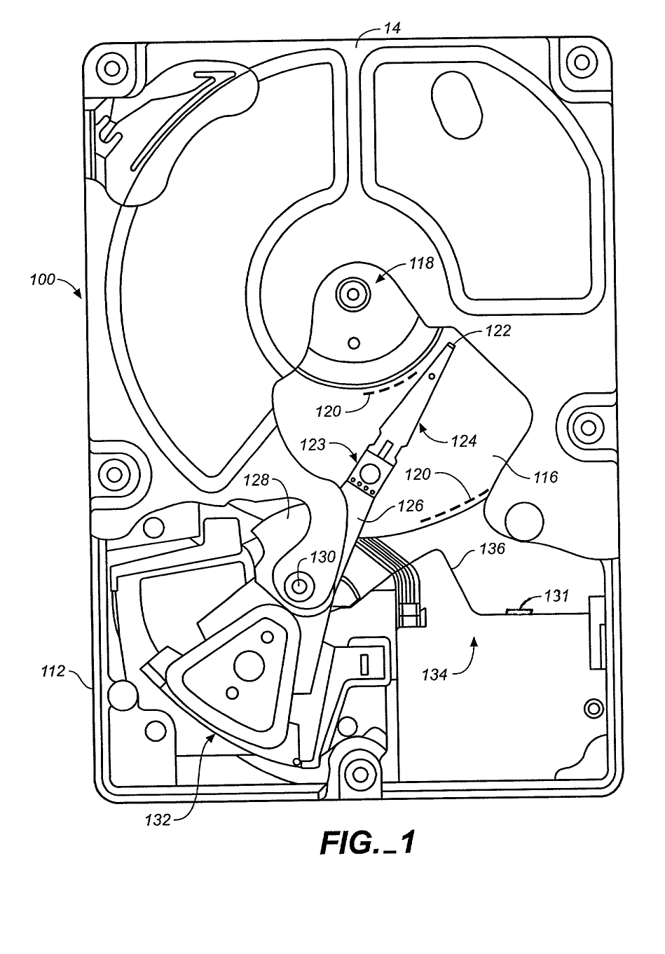

FIG. 1 is a top plan view of a disc drive in which the present invention is particularly useful. Disc drive 100 includes base member 112 to which all other components are directly or indirectly mounted. Disc drive 100 also includes top cover 114 (shown in partial cutaway), which together with base member 112 forms a disc drive housing which encloses delicate internal components and isolates these components from external contaminants.

Disc drive 100 includes a plurality of discs 116 that are mounted for rotation upon a spindle motor shown generally at 118. Discs 116 include on their surfaces a plurality of circular, concentric data tracks, the innermost and outermost are shown with dashed lines at 120, on which data are recorded via an array of vertically aligned heads 122 (one of which is shown in FIG. 1). Heads 122 are supported by load beams 124, which are attached to actuator mounting arms 126. Actuator head mounting arms 126 are illustratively integral with an actuator bearing house 128, which is mounted via an array of ball bearing assemblies (not designated) for rotation about a pivot shaft 130.

Power to drive actuator bearing housing 128 in its rotation about pivot shaft 130 is provided by a voice coil motor (VCM) shown generally at 132. VCM 132 includes a coil (not separately designated), which is supported by actuator bearing housing 128 within the magnetic filed of an array of permanent magnets (also not separately designated), which are fixably mounted to base member 112, all in a manner well known in the industry.

Electronic circuitry 134 includes a flip chip 131 that is illustratively configured to control certain aspects of the operation of disc drive 100. For instance, flip chip 131 may provide control signals that drive VCM 132. Flip chip 131 transfers and receives signals across a flex circuit cable or substrate 136. Circuitry 134 is intended to be but one example of a flex circuit application within a disc drive. Other flex circuit applications, within and outside the disc drive context, should be considered within the scope of the present invention.

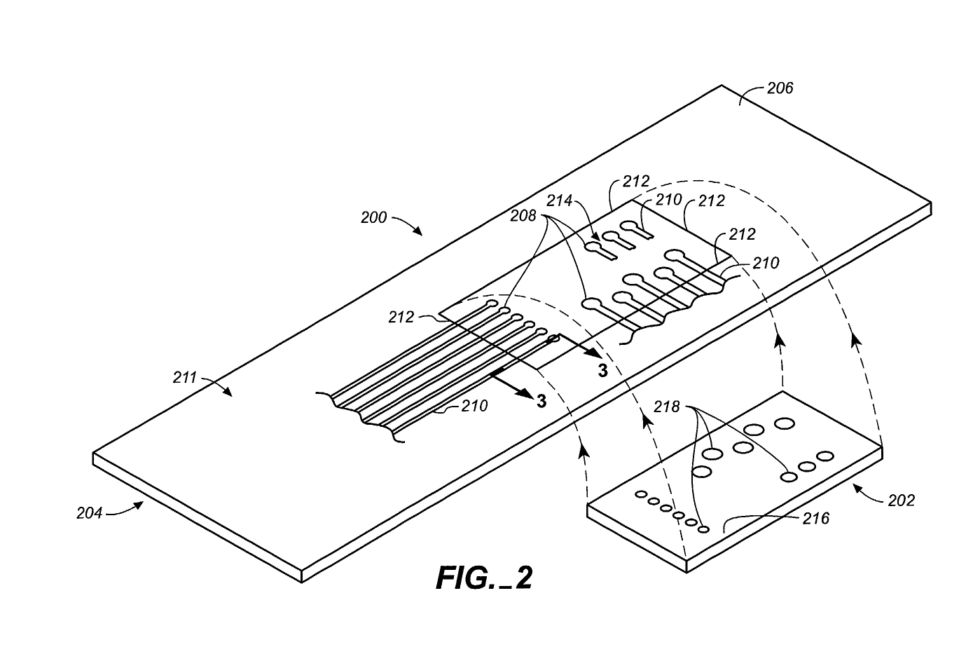

FIG. 2 is an isometric view of a flex circuit apparatus 200 in which the present invention is useful. The invention could be applied in other similar contexts without departing from the scope of the present invention.

Apparatus 200 includes a flip chip 202 that is to be attached to a flex circuit substrate 204. Flex circuit substrate 204 includes an operating surface 206. A plurality of connection pads 208 and traces 210 are operably disposed on operating surface 206 (a representative few of each have been labeled). Each connection pad 208 is adjacently and operably connected to a trace 210. A cover layer 211 of protective material is coated on operating surface 206. Cover layer 211 includes edges 212 that define an area 214 inside of which cover layer 211 does not extend. In other words, area 214 is exposed, free of cover layer 211.

Flip chip 202 includes a connection surface 216 having a plurality of connection bumps 218 (a representative few have been labeled) operably disposed thereon. Illustratively, there is a connection bump 218 that aligns with, and is designed to be soldered or connected to, each connection pad 208. It should be pointed out that an actual chip and substrate will typically include many more connection bumps 218 and connection pads 208 than the representative few illustrated in the Figures of the present description. Also, the illustrated elements of the present description are representations of actual components and are not necessarily the same size or even in direct proportion to actual component size.

In accordance with known methods, to attach flip chip 202 to flex circuit substrate 204, a wet reflowable material (i.e., a solder material) is positioned on connection pads 208. Subsequently, connection bumps 218 are aligned with and placed upon the corresponding connection pads 208. The reflowable material creates an operable connection between connection bumps 218 and traces 210 (through connection pads 208).

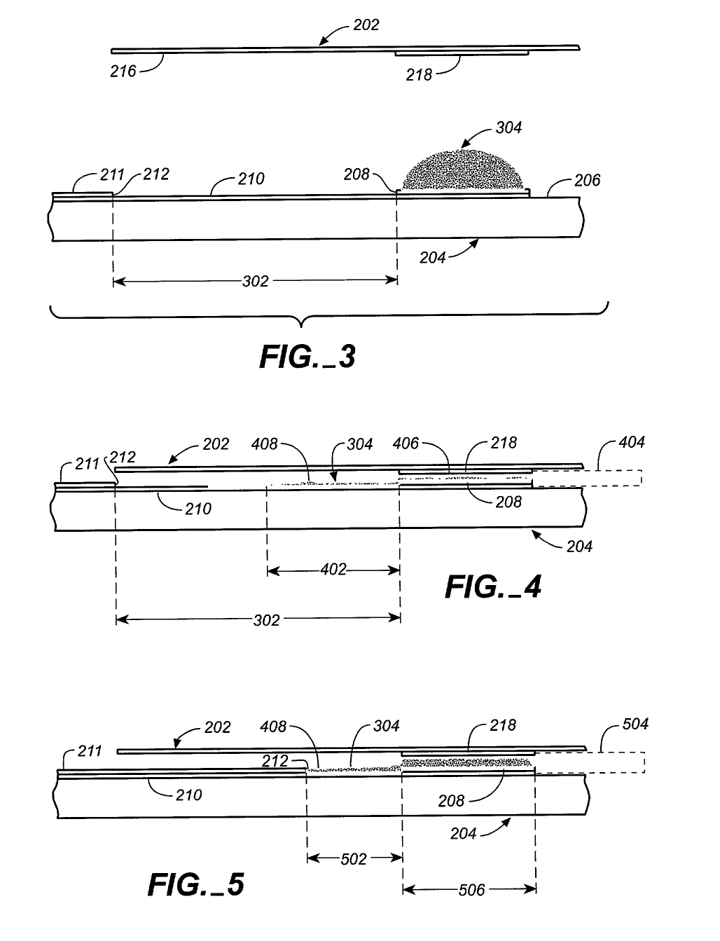

FIG. 3 is a longitudinal section taken through line 3-3 of flex circuit apparatus 200 (FIG. 2). The same or similar reference numerals are used in FIG. 3 for elements that are the same or similar to those elements illustrated and described in relation to FIG. 2.

Illustratively, FIG. 3 illustrates a moment during the process of connecting flip chip 202 to flexible substrate 204, where a reflowable material 304 has been positioned on connection pad 208, but the connection has not yet been made. Connection bump 218, which is disposed on connection surface 216, has been aligned over connection pad 208. Trace 210 and connection pad 208 are operably connected and disposed on operating surface 206. Length 302 represents the distance between pad 208 and edge 212 of cover layer 211.

FIG. 4 is a longitudinal section also taken through line 3-3 of flex circuit apparatus 200 (FIG. 2). The same or similar reference numerals are used in FIG. 4 for elements that are the same or similar to those elements illustrated and described in relation to FIGS. 2 and 3.

Illustratively, FIG. 4 depicts a moment during the process of connecting flip chip 202 to flexible substrate 204 after a connection has been made. Following connection, reflowable material 304 is illustratively separated into a first portion 406 and a second portion 408. First portion 406 represents reflowable material that stays between connection bump 218 and connection pad 208 during and following the connection process. Second portion 408 represents reflowable material that flows down trace 210 during and following the connection process.

In FIG. 4, edge 212 of cover layer 211 is separated a distance 302 from connection pad 208. Second portion 408 of reflowable material 304 illustratively extends down trace 210 a distance 402. Accordingly, cover layer 211 does not affect the flow of material 304 down trace 210 during or following the connection process. A distance or height 404 represents the distance between connection bump 218 and connection pad 208.

Illustratively, the more reflowable material 304 that flows down trace 210 during the connection process, the smaller distance 404 will become. For reasons previously addressed, this collapse of flip chip 202 during connection of flip chip 202 to flex substrate 204 can be undesirable.

With further reference to FIG. 4, in accordance with embodiments of the present invention, the collapse of chip 202 can be controlled or prevented through utilization of a barrier that crosses trace 210 and limits the distance 402 that reflowable material 304 is allowed to flow down trace 210. By limiting solder flow down trace 210 and thereby decreasing distance 402, distance 404 can be increased, thus creating a higher and more desirable first material portion 406 upon which connection bump 218 and flip chip 202 are designed to sit during and following the connection process.

FIG. 5 illustrates an embodiment of the present invention wherein edge 212 of cover layer 211 operates as a barrier to limit flow of reflowable material 304 down trace 210. The same or similar reference numerals are used in FIG. 5 for elements that are the same or similar to those elements illustrated and described in relation to the previous Figures.

In FIG. 5, edge 212 of cover layer 211 is separated a distance 502 from connection pad 208. In accordance with one embodiment, cover layer 211 is constructed of a polyamide material. It should be noted that distance 502 is significantly shorter than distance 302 in FIG. 4. Accordingly, in FIG. 5, second portion 408 of reflowable material 304 is only allowed to flow the same distance 502 down trace 210 during connection of flip chip 202 to flex circuit substrate 204. In other words, in accordance with an embodiment of the present invention, edge 212 of cover layer 211 affects the flow of material 304 down trace 210 by acting as a barrier to limit such flow.

In FIG. 5, distance or height 504 represents the distance between connection bump 218 and connection pad 208. Illustratively, height 504 in FIG. 5 is greater than height 404 in FIG. 4. This is because the more reflowable material 304 that flows down trace 210 during the connection process, the smaller distance 504 will become. In FIG. 5, because edge 212 of cover layer 211 limits the flow of material 304 down trace 210, a greater distance between connection pad 208 and connection bump 218 is achievable. In other words, in FIG. 5, in accordance with an embodiment of the present invention, edge 212 of cover layer 211 limits the collapse of flip chip 202 during and following the reflow connection process.

In accordance with embodiments of the present invention, distance 502 (FIG. 5), the distance between edge 212 and connection pad 208, can be desirably selected to produce various outcomes. For instance, manufacturing or otherwise positioning edge 212 closer to connection pad 208 illustratively increases height 504. In accordance with one embodiment, to achieve benefits such as a resilient flip chip 202 setting at an effective height 504 without eliminating all flow down trace 210, edge 212 is placed a distance 502 from connection pad 208 that is one half to two times the length of a diameter 506 of connection pad 208. Other distances, greater or smaller than this range may provide similar benefits and should also be considered within the scope of the present invention. In accordance with embodiments of the present invention, distance 502 is 5 mils or less. In accordance with embodiments of the present invention, distance 502 is selected so that it is unlikely that distance 504 will decrease below 0.5 mils.

In accordance with one embodiment, edge 212 can be brought into direct contact with connection pad 208 while crossing trace 210 and substantially blocking the flow of material 304 down the trace. In accordance with one embodiment, all of surface 206 (FIG. 2), except for connection pads 208, is covered by cover layer 211. Completely blocking flow down trace 210, while within the scope of the present invention, may be less desirable in applications where it is desired to use an indication of material 304 in trace 210 as a sign of an effective connection between flip chip 202 and trace 210 (through connection pad 208). In accordance with one embodiment, edge 212 is manufactured or otherwise positioned a distance 502 that is less than one half diameter 506 of connection pad 208.

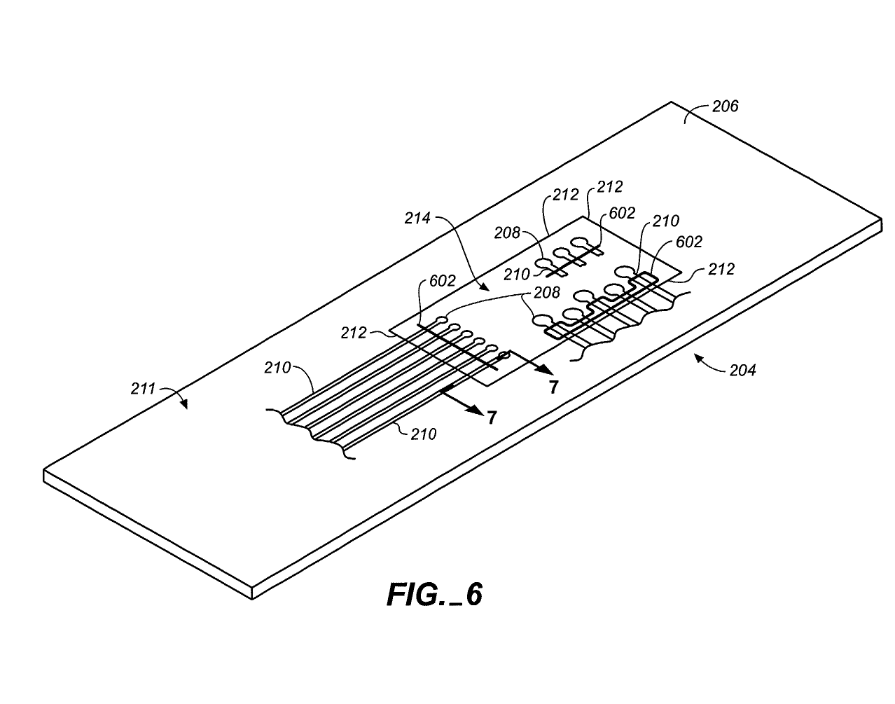

FIG. 6, in accordance with an embodiment of the present invention, is an isometric view of flex circuit substrate 204, including a plurality of barrier strips 602 that are disposed on surface 206 and operate as barriers to limit flow of reflowable material down traces 210. The same or similar reference numerals are used in FIG. 6 for elements that are the same or similar to those elements illustrated and described in relation to the previous Figures.

In FIG. 6, flex substrate 204 includes operating surface 206. A plurality of connection pads 208 and 210 are operably disposed on operating surface 206 (a representative few of each have been labeled). Each connection pad 208 is adjacently and operably connected to a trace 210. Cover layer 211 of protective material is coated on operating surface 206. Cover layer 211 includes edges 212 that define an area 214 inside of which cover layer 211 does not extend. In other words, area 214 is exposed, free of cover layer 211.

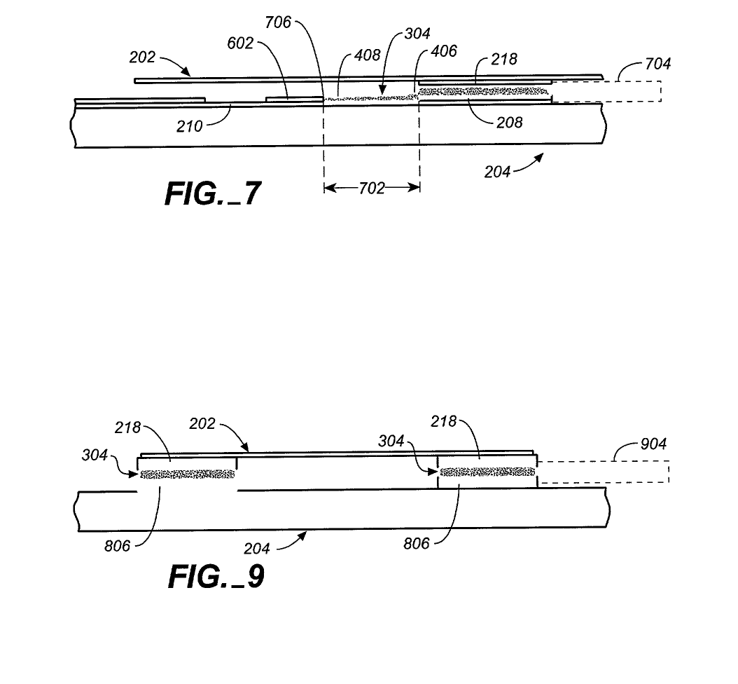

Connection pads 208 and at least a portion of a corresponding trace 210 are illustratively within area 214. It should be noted that, although not illustrated, substrate 204 could include other connection pads 208 and traces 210 that are not disposed within area 214. As will be described in more detail in relation to FIG. 7, in accordance with an embodiment of the present invention, barrier strips 602 cross traces 210 within area 214 and are configured, similar to cover layer barrier or edge 212 in FIG. 5, to limit flow of reflowable material down traces 210. In accordance with embodiments of the present invention, barrier strips 602 are created using the method of presenting and curing a solder mask, either a dry film or liquid photoimageable, to define barrier strips 602 inside area 214 at a desired distance from connection pads 208. In accordance with one embodiment, barrier strips 602 are constructed of a polyamide material. The shapes and alignments of barrier strips 602 in FIG. 6 should only be considered illustrative of many different potential shapes and alignments. In accordance with one embodiment, a cover layer barrier, as described in relation to FIG. 5 can be used for some connection pads 208 while barrier strips 602 are used for other connection pads 208.

FIG. 7 is a longitudinal section taken through line 7-7 (FIG. 6) of flex circuit substrate 204. FIG. 7 includes a flip chip 202 and is intended to depict a moment during the chip-substrate connection process after reflowable material 304 has been positioned on connection pad 208 and after flip chip 202 has been connected to flex circuit substrate 204. The same or similar reference numerals are used in FIG. 7 for elements that are the same or similar to those elements illustrated and described in relation to previous Figures.

In FIG. 7, following connection of flip chip 202 to flex substrate 204, reflowable material 304 is illustratively separated into first portion 406 and second portion 408. First portion 406 again represents reflowable material that stays between connection bump 218 and connection pad 208 during and following the connection process. Second portion 408 represents reflowable material that flows down trace 210 during and following the connection process.

In FIG. 7, edge 212 of cover layer 211 is positioned behind barrier strip 602. Accordingly, cover layer 211 does not affect the flow of material 304 down trace 210 during or following the connection process. Barrier strip 602, however, in accordance with an embodiment of the present invention, operates as a barrier to limit flow of reflowable material 304 down trace 210. An edge 706 of barrier strip 602 is separated a distance 702 from contact pad 208. Accordingly, second portion 408 of reflowable material 304 is only allowed to flow distance 702 down trace 210 during and following connection of flip chip 202 to flex circuit substrate 204. In other words, in accordance with an embodiment of the present invention, edge 706 of barrier strip 602 affects the flow of material 304 down trace 210 by acting as a barrier to limit such flow.

In FIG. 7, distance or height 704 represents the distance between connection bump 218 and connection pad 208. Illustratively, height 704 is correlated to the amount of material 304 that is allowed to flow down trace 210 before encountering barrier strip 602. Illustratively, if distance 702 is increased, then distance 704 will decrease. In other words, in accordance with an embodiment of the present invention, barrier strip 602 can be manufactured or otherwise positioned to selectively limit the collapse of flip chip 202 during and following the reflow connection process.

In accordance with an embodiment of the present invention, distance 702 (FIG. 7), the distance between edge 706 and connection pad 208, can be desirably selected to produce various outcomes. Distance 702 can be selected within a variety of ranges, depending on a variety of desired outcomes. Distance 702 can illustratively be selected in a manner similar to the selection of distance 502, as described above in relation to the cover layer barrier embodiment described in relation to FIG. 5.

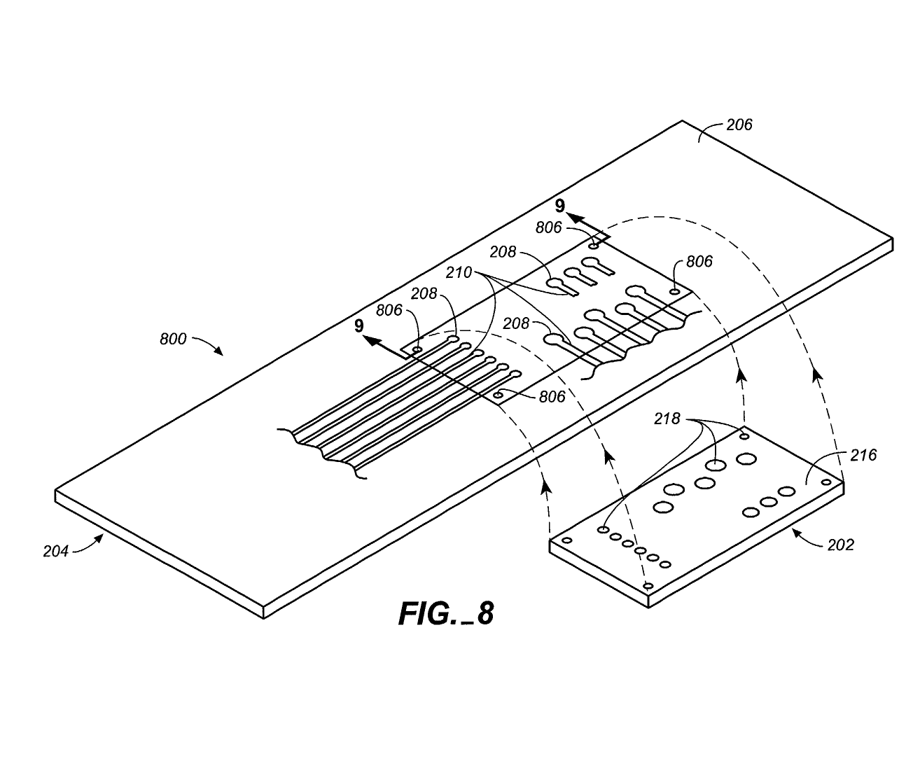

FIG. 8 is an isometric view of a flex circuit apparatus 800 having a plurality of traceless pad connections 806, in accordance with an embodiment of the present invention. The same or similar reference numerals are used in FIG. 8 for elements that are the same or similar to those elements illustrated and described in relation to previous Figures.

Apparatus 800 includes a flip chip 200 that is to be attached to a flex circuit substrate 204. Flex circuit substrate 204 includes an operating surface 206. A plurality of connection pads 208 and traces 210 are operably disposed on operating surface 206 (a representative few of each have been labeled). Each connection pad 208 is adjacently and operably connected to a trace 210. Illustratively, traceless pad connections 806, however, are not connected to any trace.

Flip chip 202 includes a connection surface 216 having a plurality of connection bumps 218 (a representative few have been labeled) operably disposed thereon. Illustratively, there is a connection bump 218 that aligns with, and is designed to be soldered or connected to, each connection pad 208, including each traceless pad connection 806.

In accordance with the present invention, to attach flip chip 202 to flex circuit substrate 204, a wet reflowable material (i.e., solder material) is positioned on connection pads 208 and traceless pad connections 806. Subsequently, connection bumps 218 are aligned with and placed upon the corresponding connection pads 208 and traceless pad connections 806. The reflowable material creates an operable connection between connection bumps 218 and traces 210 (through connection pads 208). Illustratively, as described above, a portion of the reflowable material deposited on the connection pads 208 typically flows down traces 210 causing flip chip 202 to at least partially collapse towards flex circuit substrate 204.

In accordance with an embodiment of the present invention, traceless pad connections 806 limit such a collapse. Illustratively, traceless pad connections 806 are not electrically connected to any circuitry or traces on flex circuit substrate 204. Thus, during the reflow process, connections 806 do not significantly suffer from flow out of reflowable material placed thereon. The result of this reflowable material containment is a “pillow” effect that maximizes the distance between flip chip 202 and flex circuit 204 during and following the reflow attachment process. Illustratively, the effect of traceless pad connections 806 on connection pads 208 is that reflowable material that typically runs down traces 210 due to collapse of flip chip 202 remains on connection pads 208, thereby enabling more repeatable reflow connections.

FIG. 9 is a longitudinal section taken through line 9-9 of flex circuit apparatus 800 (FIG. 8), after reflowable material 304 has been positioned and after a connection of flip chip 202 to flex circuit substrate 204. The same or similar reference numerals are used in FIG. 9 for elements that are the same or similar to those elements illustrated and described in relation to previous Figures.

In accordance with an embodiment of the present invention, because traceless connection pads 806 are not connected to or associated with a trace, none (or very little) of reflowable material 304 escapes from between connection bumps 218 and pads 806 during or following the reflow connection process. Accordingly, distance or height 904, the distance between connection bumps 218 and pads 806, remains at an illustratively desirable value during and following the reflow connection process. In accordance with one embodiment, the amount of reflowable material 304 positioned on traceless pads 806 can be selected to directly affect and influence a desired distance 904.

In FIGS. 8 and 9, an illustrative one traceless pad 806 lines up with each corner of flip chip 202. It should be noted that other traceless pad 806 configurations should be considered within the scope of the present invention. For instance, a single or more than one traceless pad 806 could be manufactured or otherwise placed on flex circuit substrate 204 so as to line up in any number of configurations that enable effective support of flip chip 202 over flex circuit substrate 204, during and following reflow attachment. All of such configurations should be considered within the scope of the present invention. In addition, the traceless pad 806 embodiment of the present invention could be combined with previously described trace 210 barrier embodiments without departing from the scope of the present invention.

In summary, a flex circuit apparatus embodiment for a disc drive (such as 100) configured to limit a collapse of a chip (such as 202) during reflow attachment of the chip (such as 202) to a flex circuit substrate (such as 204) includes a connection pad (such as 208) and a trace (such as 210) operably disposed on an operating surface (such as 206) of the flex circuit substrate (such as 204). The trace (such as 210) is adjacently and operably connected to the connection pad (such as 208). A barrier (such as 212 or 706) crosses the trace (such as 210) and is configured to limit a flow of material (such as 304) down the trace (such as 210).

In one embodiment, the barrier (such as 212 or 706) is spaced from the connection pad (such as 208). In another embodiment, the connection pad (such as 208) has a diameter (such as 506) and the barrier (such as 212 or 706) is spaced from the connection pad (such as 208) a distance (such as 502 or 702) that is less than one-half the diameter (such as 506) of the connection pad (such as 208), the barrier (such as 212 or 706) being configured to substantially block the flow of material (such as 304) down the trace (such as 210).

In another embodiment, the barrier (such as 212 or 706) contacts the connection pad (such as 208), the barrier (such as 212 or 706) being configured t eliminate the flow of material (such as 304) down the trace (such as 210). In another embodiment, the connection pad (such as 208) has a diameter (such as 506) and the barrier (such as 212 or 706) is spaced from the connection pad (such as 208) a distance that falls within a range of approximately one-half to two times the diameter (such as 506) of the connection pad (such as 208).

In another embodiment, the barrier (such as 212) is formed by a cover layer (such as 211) that is selectively deposited on and covers a substantial portion of the operating surface (such as 206) of the flex circuit substrate (such as 204). In another embodiment, the barrier (such as 212) is formed by a cover layer (such as 211) that covers the trace (such as 210) and a substantial portion of the operating surface (such as 206) of the flex circuit substrate (such as 204), the connection pad (such as 208) being exposed, free of the cover layer (such as 211).

In another embodiment, the barrier (such as 212) is formed by a cover layer (such as 211) that is disposed on a substantial portion of the operating surface (such as 206) of the flex circuit substrate (such as 204), the connection pad (such as 208) and a portion of the trace (such as 210) proximate the connection pad (such as 208) being exposed, free of the cover layer (such as 211).

In another embodiment, the flex circuit substrate (such as 204) further comprises a cover layer (such as 211) selectively deposited on the operating surface (such as 206) thereof. A length of the trace (such as 210) located between the connection pad (such as 208) and the barrier (such as 212) is exposed and free of the cover layer (such as 211). The barrier (such as 212) is formed by the cover layer (such as 211).

In another embodiment, the barrier (such as 706) is formed by a selectively deposited barrier strip (such as 602) disposed on the operating surface (such as 206) of the flex circuit substrate (such as 204). In another embodiment, the barrier strip (such as 602) is constructed of a cured dry film solder mask (such as 602). In another embodiment, the barrier strip (such as 602) is constructed of a liquid photoimageable solder mask (such as 602).

In another embodiment, the flex circuit substrate (such as 204) includes a cover layer (such as 211) that is disposed on the operating surface (such as 206) thereof and has an open area (such as 214) where the operating surface (such as 206) is exposed and free of the cover layer (such as 211). The connection pad (such as 208) and a length of the trace (such as 210) are located within the cover layer open area (such as 214). The barrier (such as 706) is formed by a barrier strip (such as 602) disposed on the operating surface (such as 206) of the flex circuit substrate (such as 204) and located within the cover layer open area (such as 214).

In another embodiment, a plurality of leadless connection pads are (such as 806) electrically disconnected from, and disposed on the operating surface (such as 206) of, the flex circuit substrate (such as 204). The leadless connection pads (such as 806) are configured to vertically support the chip (such as 202) and limit the collapse of the chip (such as 202) during reflow attachment.

In a method embodiment for limiting a collapse of a chip (such as 202) during a reflow attachment of the chip (such as 202) to a flex circuit substrate (such as 204), a chip (such as 202) having a connection surface (such as 216) that includes a plurality of connection bumps (such as 218) is obtained. A flex circuit substrate (such as 204) that includes an operating surface (such as 206) having a plurality of connection pads (such as 208) that substantially align with the plurality of connection bumps (such as 218), at least one of the connection pads (such as 218) being a non-operational traceless pad (such as 806), is obtained. Reflowable material (such as 304) is positioned on the plurality of connection pads (such as 208). The plurality of connection bumps (such as 218) are connected to the corresponding plurality of connection pads (such as 208 and 806).

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular flex circuit application while maintaining substantially the same functionality without departing from the scope and spirit of the present invention. In addition, although the preferred embodiment described herein is directed to a flex circuit apparatus for a disc drive system, it will be appreciated by those skilled in the art that the teachings of the present invention can be applied to other systems, like other computer component environments or other electronic device systems, without departing from the scope and spirit of the present invention.

What is claimed is:

1. A flex circuit apparatus for a disc drive configured to limit a collapse of a chip during a reflow attachment of the chip to a flex circuit substrate, the apparatus comprising:
a connection pad and a trace operably disposed on an operating surface of the flex circuit substrate, the trace being adjacently and operably connected to the connection pad; and
a barrier that crosses the trace and is configured to limit a flow of material down the trace.

2. The apparatus of claim 1, wherein the barrier is spaced from the connection pad.

3. The apparatus of claim 1, wherein the connection pad has a diameter and the barrier is spaced from the connection pad a distance that is less than one-half the diameter of the connection pad, the barrier being configured to substantially block the flow of material down the trace.

4. The apparatus of claim 1, wherein the barrier contacts the connection pad, the barrier being configured to eliminate the flow of material down the trace.

5. The apparatus of claim 1, wherein the connection pad has a diameter and the barrier is spaced from the connection pad a distance that falls within a range of approximately one-half to two times the diameter of the connection pad.

6. The apparatus of claim 1, wherein the barrier is formed by a cover layer that is selectively deposited on and covers a substantial portion of the operating surface of the flex circuit substrate.

7. The apparatus of claim 1, wherein the barrier is formed by a cover layer that covers the trace and a substantial portion of the operating surface of the flex circuit substrate, the connection pad being exposed, free of the cover layer.

8. The apparatus of claim 1, wherein the barrier is formed by a cover layer that is disposed on a substantial portion of the operating surface of the flex circuit substrate, and wherein the connection pad and a portion of the trace proximate the connection pad are exposed, free of the cover layer.

9. The apparatus of claim 1, wherein:
the flex circuit substrate further comprises a cover layer selectively deposited on the operating surface thereof;
a length of the trace located between the connection pad and the barrier is exposed and free of the cover layer; and
the barrier is formed by the cover layer.

10. The apparatus of claim 1, wherein the barrier is formed by a selectively deposited barrier strip disposed on the operating surface of the flex circuit substrate.

11. The apparatus of claim 10, wherein the barrier strip is constructed of a cured dry film solder mask.

12. The apparatus of claim 10, wherein the barrier strip is constructed of a cured liquid photoimageable solder mask.

13. The apparatus of claim 1, wherein:
the flex circuit substrate further comprises a cover layer that is disposed on the operating surface thereof and includes an open area where the operating surface is exposed and free of the cover layer;
the connection pad and a length of the trace proximate the connection pad are located within the cover layer open area; and
the barrier is formed by a barrier strip disposed on the operating surface of the flex circuit substrate and located within the cover layer open area.

14. The apparatus of claim 1, further comprising a plurality of leadless connection pads electrically disconnected from, and disposed on the operating surface of, the flex circuit substrate, the leadless connection pads being configured to vertically support the chip and limit the collapse of the chip during reflow attachment.

15. A method for limiting a collapse of a chip during a reflow attachment of the chip to a flex circuit substrate, the method comprising:
obtaining a chip having a connection surface that includes a plurality of connection bumps;
obtaining a flex circuit substrate that includes an operating surface having a plurality of connection pads that substantially align with the plurality of connection bumps, at least one of the connection pads being a non-operational traceless pad;
positioning reflowable material on the plurality of connection pads; and
connecting the plurality of connection bumps to the corresponding plurality of connection pads.

16. A flex circuit apparatus, comprising:
a chip;
a flex circuit substrate; and
means for limiting a collapse of the chip during a reflow attachment of the chip to the flex circuit substrate.

17. The flex circuit apparatus of claim 16, wherein the means for limiting the collapse of the chip comprises a barrier that crosses the trace and is configured to limit a flow of material down the trace during the reflow attachment.

18. The flex circuit apparatus of claim 17, wherein the flex circuit substrate includes a connection pad and a trace operably disposed on an operating surface thereof, the trace being adjacently and operably connected to the connection pad, and wherein the barrier is formed by a cover layer disposed on the operating surface of the flex circuit substrate, the connection pad and a portion of the trace proximate the connection pad being exposed and free of the cover layer.

19. The flex circuit apparatus of claim 17, wherein the barrier is formed by a selectively deposited barrier strip disposed on the flex circuit substrate.

20. The flex circuit apparatus of claim 16, wherein the means for limiting the collapse of the chip comprises at least one non-operational leadless connection pad electrically disconnected from, and disposed on an operating surface of, the flex circuit substrate, wherein the at least one non-operational leadless connection pad is configured to vertically support the chip and limit the collapse of the chip during the reflow attachment.
